(19) United States
(12) Patent Application Publication
(10) Pub. No.: US 2026/0299103 A1
(43) Pub. Date: Oct. 1, 2026

(54) HOUSING FOR ULTRASONIC TRANSDUCERS, SAID HOUSING HAVING DIFFERENTLY INCLINED BOTTOM SURFACES

(71) Applicant: VALEO SCHALTER UND SENSOREN GMBH, Bietigheim-Bissingen (DE)

(72) Inventors: Fabian Haag, Bietigheim-Bissingen (DE); Hans-Wilhelm Wehling, Bietigheim-Bissingen (DE); Joerg Weyland, Bietigheim-Bissingen (DE)

(73) Assignee: VALEO SCHALTER UND SENSOREN GMBH, Bietigheim-Bissingen (DE)

(21) Appl. No.: 19/100,835

(22) PCT Filed: Jul. 17, 2023
(86) PCT No.: PCT/EP2023/069762

§ 371 Date: Feb. 3, 2025

(30) Foreign Application Priority Data
Aug. 3, 2022 (DE) 10 2022 119 465.5

(51) Int. Cl. G01S 7/521; G01S 15/931

(52) U.S. Cl. CPC G01S 7/521; G01S 15/931

(57) ABSTRACT

A housing for an ultrasonic transducer for detecting an object in the surroundings of a vehicle includes a circumferential side wall, which defines a main axis of the housing; and a bottom wall, which has a central receptacle for supporting a transducer element and at least one modulator area. The modulator area extends in a plane of longitudinal section, which contains the main axis, radially from the receptacle to a transition of the bottom wall into the side wall. A thickness of the bottom wall decreases radially outward over the entire modulator area. An inner side of the bottom wall in the modulator area has at least two different angles of inclination.

The present invention relates to a housing for an ultrasonic transducer for detecting an object in the surroundings of a vehicle, furthermore an ultrasonic transducer for detecting an object in the surroundings of a vehicle, and a vehicle.

Ultrasonic transducers for detecting an object in the surroundings of a vehicle are used, for example, for parking systems or the like. Such ultrasonic transducers often function according to the pulse-echo principle, wherein the same ultrasonic transducer is used as transmitter and receiver. It is therefore particularly difficult to design the smallest possible “blind zone” at close range, from which no echo signal can be received or reliably detected. The size of this “blind zone” is characterized and determined by a reverberation time of the transducer after an emission of the pulse.

To obtain a high electroacoustic conversion efficiency and therefore a broad detection range and/or a low signal-to-noise ratio, ultrasonic transducers are generally based on the bending transducer principle. A piezoelectric transducer disk is applied to a membrane and operated in a resonance mode.

To assist this and avoid echoes from a roadway and/or very tall objects, such as roofs in parking garages and/or bridges, in general a pronounced directional characteristic and a narrow aperture angle are pursued. This can be achieved, for example, by a special membrane geometry.

One example of this is JP 2001 326987 A. This discloses a cup-like housing for an ultrasonic transducer, the bottom of which has a central circular-disk-shaped thickening. This design sometimes displays a low electroacoustic efficiency, which shortens a detection range of the resulting ultrasonic transducer. Furthermore, a long reverberation time after an emission of an ultrasonic pulse can be provided with this design, by which a blind area at close range is enlarged.

JP 2006 174 003 teaches a design for improving the reverberation time, for example. This discloses a rotationally-symmetrical cup-shaped housing for an ultrasonic transducer. A bottom section of the housing has the shape of a truncated cone, the thickness of which increases inward from a side wall toward a central plateau for a transducer element with constant slope.

Sharp edges can possibly be complex to manufacture in JP 2006 174 003. In addition, variations in the radius can display strong interactions with a resonance frequency.

DE 11 2009 003 590 T5 discloses an ultrasonic transducer having improved stability of the resonance frequency. The described ultrasonic transducer comprises a circular cylindrical housing provided with a lower side and a piezoelectric element, which is provided essentially at a center of a lower side of the housing. The lower side of the housing has a sloped section, which becomes thinner gradually from a position at which the piezoelectric element is provided to an inner wall surface of the housing, and a flat section, which extends from an outer edge of the sloped section to the inner wall surface of the housing, while a thickness of the outer edge of the sloped section is maintained.

In particular, the reverberation time can be extended in a design which is shown in FIG. 3 of DE 11 2009 003 590T5. The disclosed housing tends to display visible burrs on a vehicle body outer side in the installed state. In comparison to a design according to abovementioned JP 2001 326987 A, a directional characteristic is possibly worsened and the aperture angle is widened. In addition, the electroacoustic efficiency can be reduced.

Further housings for ultrasonic transducers are known in the prior art:

JP 2005 039 689 A discloses a cup-like housing for an ultrasonic transducer having a flat bottom. On one side, the flat bottom is provided with one flat step or multiple flat steps toward the outer side of the bottom, so that one further thinner or multiple further thinner bottom sections result. The one-sidedness results in tilting of an ultrasonic detection cone in relation to a longitudinal axis of the housing. The tilting has the result that the ultrasonic detection cone is not symmetrical to the longitudinal axis. Therefore, an orientation of the sensor is to be observed during an installation. This concept can be unsuitable for an embodiment in which an asymmetrical cable connection is provided and/or identical parts are required for right and left in a vehicle body. In other words, the housing of JP 2005 039 689 A is unsuitable for embodiments which require a symmetrical overall sensor structure.

JP 2017 225 013 A discloses a housing in the form of a circular disk for an ultrasonic transducer having a central oval recess. This oval recess has a flat bottom, which has kidney-shaped depressions having thinner, flat bottoms on the short sides. A stepped course of the bottom thickness having flat steps results in the cross section along a longitudinal axis of the oval recess.

DE 10 2008 040905 A 1 discloses a cup-like housing for an ultrasonic sensor having a bottom surface and a side wall. An electromechanical transducer element, such as a piezoelectric element in the form of a cylindrical disk, is adhesively bonded on an otherwise flat inner side of the bottom surface.

Against this background, one object of the present invention is to provide an improved ultrasonic transducer and in particular a housing for this transducer. An advantageous compromise between directional characteristic, electroacoustic efficiency, and/or short reverberation time is in the foreground here.

Accordingly, a housing for an ultrasonic transducer for detecting an object in the surroundings of a vehicle is proposed. The housing has a circumferential side wall and a bottom wall. The circumferential side wall defines a main axis of the housing. The bottom wall has a central receptacle for supporting a transducer element or ultrasonic element and at least one modulator area. The modulator area extends in a plane of longitudinal section, which contains the main axis, radially from the receptacle to a transition of the bottom wall into the side wall. A thickness of the bottom wall decreases radially outward over the entire modulator area. An inner side of the bottom wall has at least two different angles of inclination in the modulator area.

The housing implements a compromise in the bottom wall. On the one hand, the housing is distinguished by a directional characteristic which is achieved by means of a large aperture in the plane of longitudinal section. On the other hand, the bottom wall is distinguished by a high electroacoustic efficiency, which is achieved by appropriate shaping of the modulator area. In addition, the proposed housing is suitable for a desirably short reverberation time and is finally also robust with respect to variations in manufacturing tolerances. The proposed housing can be manufactured well due to the proposed bottom wall.

In particular in the plane of longitudinal section, a thickness of the bottom wall decreases radially outward over the entire modulator area. The inner side of the bottom wall has at least two different angles of inclination in the modulator area, in particular in the plane of longitudinal section.

The side wall is preferably closed in the circumferential direction, however, variants having a wall which is not continuous and/or partially not continuous in the circumferential direction are also conceivable.

The bottom wall has an outer side, which preferably extends perpendicularly to the main axis. Variants are also conceivable in which the outer side is concavely and/or convexly curved and/or extends in the form of a truncated cone and/or to a point.

The inner side of the modulator area preferably extends in a convex rounding in the plane of longitudinal section. A tendency toward reverberation is thus reduced, i.e. improved. It is conceivable both that the entire modulator area is embodied as a convex rounding and that an area of the modulator area is embodied as a convex rounding.

In this description, the terms “convex” and “concave” relate to an observer in an interior of the housing. “Convex” means directed outward, in particular rounded, viewed from the inside in the housing. Colloquially, “convex” can be viewed as a bulge “outward”. Functionally, a “convex” section of an inner side of the bottom wall corresponds to more inner volume of the housing. “Concave” means directed inward, in particular rounded, viewed from the inside in the housing. Colloquially, “concave” can be viewed as a bulge “inward”. Functionally, a “concave” section of an inner side of the bottom wall corresponds to less inner volume of the housing.

According to one preferred option, a continuously differentiable course of the inner side in the plane of longitudinal section is conceivable. Examples comprise a parabolic and/or exponential course. A frequency behavior can be improved in this way. It is conceivable that the inner side extends in a continuously differentiable manner over the entire modulator area. Furthermore, it is conceivable that the inner side extends in a continuously differentiable manner over only a part of the modulator area.

For reasons of electroacoustic efficiency, it is preferred for an outer edge of the rounding and/or parabola to tangentially abut an imaginary truncated cone angle.

If the modulator area contains multiple truncated cone sections, which have at least two different angles of inclination, a mold for the housing can be manufactured comparatively easily. If two adjacent truncated cone sections, in particular radially adjacent truncated cone sections, merge into one another through a convex rounding, damping can be improved and reverberation can be reduced. However, it is also conceivable that two adjacent truncated cone sections, in particular radially adjacent truncated cone sections, merge into one another through an edge, so that a natural frequency behavior becomes more pronounced. Both are preferable refinements depending on the design.

For reasons of electroacoustic efficiency, it is again preferable for a surface section of the modulator area to be arranged farther radially outward the flatter the respective surface section is. For example, if two truncated cone sections having different angles of inclination are provided, it is more electroacoustically efficient to arrange the flatter truncated cone section radially outside the steeper truncated cone section. Specifications such as “flat” and “steep” preferably relate to an imaginary perpendicular to the imaginary main axis.

If the modulator area or one modulator area in each case extends symmetrically to the main axis in the plane of longitudinal section, a directional characteristic of the ultrasonic transducer symmetrical to the main axis is achievable. For example, a horizontally wide and vertically narrow ultrasonic cone can thus be provided.

If the side wall also extends to the receptacle in a second plane of longitudinal section, which contains the main axis and is perpendicular to the plane of longitudinal section, an advantageous directional characteristic can be achieved. Specifically, an effective aperture can be narrower in the direction of the second plane of longitudinal section than in the direction of the first plane of longitudinal section, so that a directional characteristic is wider in this direction of the second plane of longitudinal section. According to a preferred example, the side wall has a thickening that is parallel and/or at least approximately parallel and/or parallel in sections to the plane of longitudinal section. An inner wall of the thickening can optionally extend concentrically to the receptacle.

Experiments have shown that in an electroacoustically efficient housing, an angle of inclination on the inside in the modulator area is at least 2°, preferably at least 2.5°, and more preferably at least 3°. “Inside” in the modulator area means that a rounding which merges into the preferably flat receptacle and/or a rounding which merges into the preferably steep side wall can have a lower angle of inclination. An angle of inclination of 0° accordingly means a perpendicular to the main axis and an angle of inclination of 90° accordingly means a parallel to the main axis.

If the side wall is interrupted at least in some sections in the circumferential direction and/or protrudes by different amounts from the main axis viewed along the circumferential direction, the housing can contain a twist lock. In this way, a desired orientation of a directional characteristic in relation to a vehicle can be securely set.

An inner side of the bottom wall preferably merges by means of a concave rounding from the modulator area into the receptacle. The housing thus becomes more tolerant with respect to manufacturing variations.

To be able to manufacture the housing more easily, it is proposed as an option that an inner side of the bottom wall merge by means of a convex rounding from the modulator area into an inner side of the side wall.

It is favorable for attaching a disk-shaped transducer element if the receptacle has a constant thickness.

According to a further aspect of the invention, an ultrasonic transducer is proposed. This has a housing according to one of the above options and a transducer element. The transducer element is supported in and/or on the receptacle, for example, by means of an adhesive bond, a weld, and/or a chemical and/or mechanical fastening method.

According to still a further aspect, a vehicle is proposed which contains at least one such ultrasonic transducer.

The vehicle is, for example, a passenger vehicle or even a truck.

Further possible implementations of the invention also comprise not explicitly mentioned combinations of features or embodiments described above or below with regard to the exemplary embodiments. A person skilled in the art will in this case also add individual aspects as improvements or additions to the respective basic form of the invention.

Further advantageous configurations and aspects of the invention are the subject of the dependent claims and of the exemplary embodiments of the invention that are described below. The invention is explained in more detail below on the basis of preferred embodiments with reference to the accompanying figures.

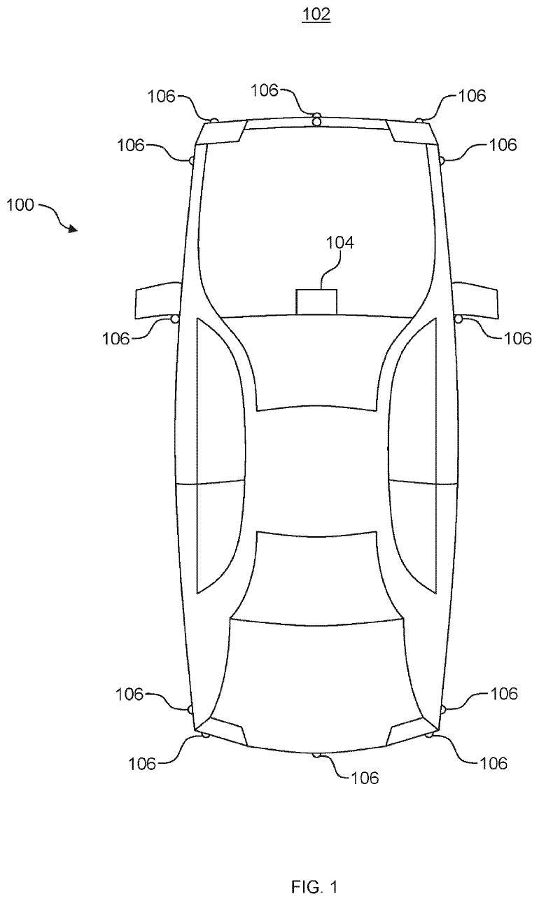

FIG. 1 shows a schematic top view of a vehicle which contains multiple ultrasonic transducers;

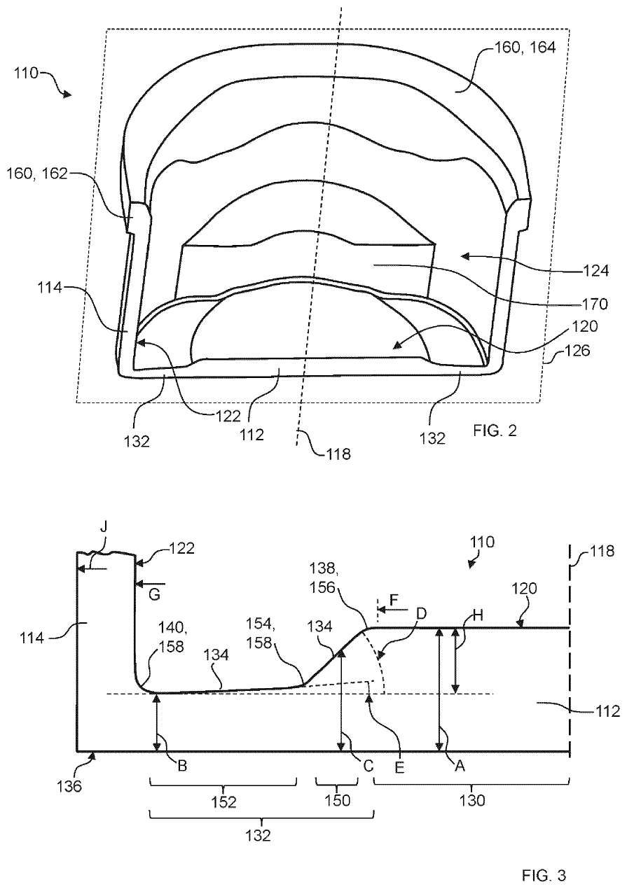

FIG. 2 shows a schematic perspective sectional view of a housing for an ultrasonic transducer according to a first embodiment of the invention;

FIG. 3 shows a schematic view in longitudinal section of a part of a bottom wall and a part of a side wall of the housing for an ultrasonic transducer according to the first embodiment of the invention;

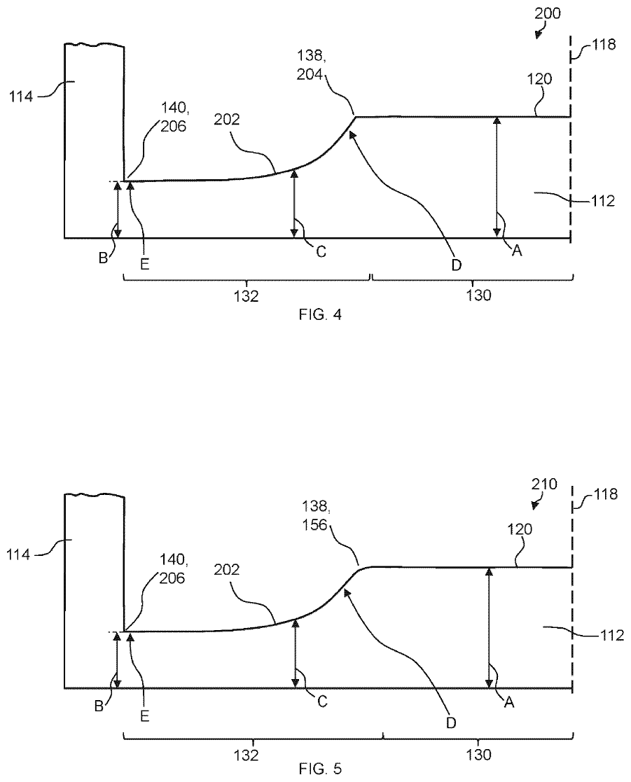

FIG. 4 shows a schematic view in longitudinal section of a part of a bottom wall and a part of a side wall of a housing for an ultrasonic transducer according to a second embodiment of the invention;

FIG. 5 shows a schematic view in longitudinal section of a part of a bottom wall and a part of a side wall of a housing for an ultrasonic transducer according to a third embodiment of the invention;

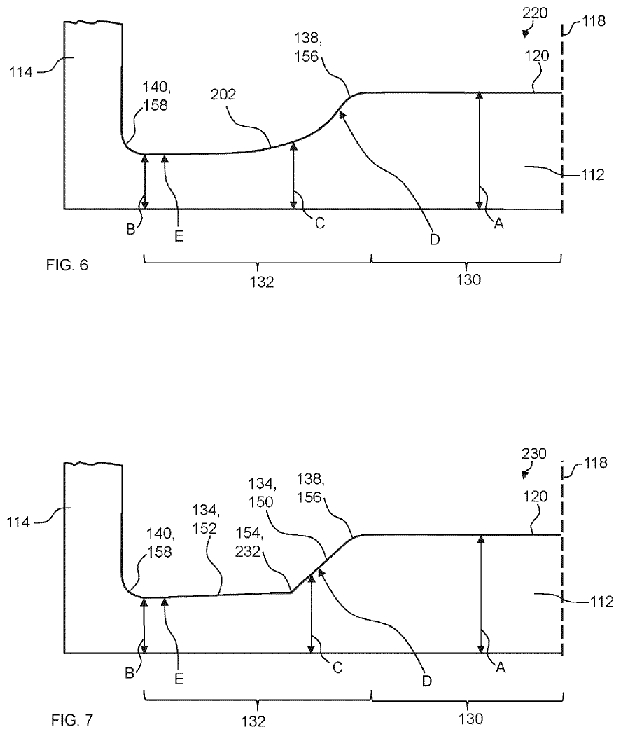

FIG. 6 shows a schematic view in longitudinal section of a part of a bottom wall and a part of a side wall of a housing for an ultrasonic transducer according to a fourth embodiment of the invention; and

FIG. 7 shows a schematic view in longitudinal section of a part of a bottom wall and a part of a side wall of a housing for an ultrasonic transducer according to a fifth embodiment of the invention.

Identical or functionally identical elements have been provided with the same reference signs in the figures, unless stated otherwise.

FIG. 1 shows a schematic view of a vehicle 100 from a bird's eye perspective. The vehicle 100 is, for example, an automobile that is arranged in the surroundings 102. The automobile 100 has a control unit 104. Moreover, multiple ultrasonic transducers 106 are provided on the automobile 100. The ultrasonic transducers 106 are configured to detect a distance from objects arranged in the surroundings 102 and to output a corresponding sensor signal. The ultrasonic transducers 106 are connected to the control unit 104.

FIGS. 2 and 3 show a housing 110 for an ultrasonic transducer 106 according to a first embodiment of the housing 110.

FIG. 2 shows the structure of the housing 110 in a prospective longitudinal section. The housing 110 has a bottom wall 112 and a side wall 114.

The side wall 114 is circumferentially closed and thus forms a tube shaped irregularly on the inside. The side wall 114 defines a main axis 118 in its center.

At one axial end of the side wall 114, the housing is closed like a cup by the approximately disk-shaped bottom wall 112. An inner side 120 of the bottom wall 112 and an inner side 122 of the side wall 114 delimit an interior 124 of the housing 110.

In the illustration of FIG. 2, the housing 110 is in section in a plane of longitudinal section 126, which contains the main axis 118.

FIG. 3 shows a part of the longitudinal section of FIG. 2 in a top view of the sectional surface. FIG. 3 thus shows the section of the housing 110 with the plane of longitudinal section 126. A part of the side wall 114 is shown on the left in the image and the main axis 118 is shown on the right in the image.

The bottom wall 112 has a receptacle 130 and a modulator area 132 radially outward from the main axis 118. The side wall 114 abuts the modulator area 132 on the radial outside.

The receptacle 130 is an area of the bottom wall 112 which is prepared to support a transducer element (not shown). A piezoelectric element for converting between mechanical oscillations and electrical oscillations in the ultrasonic range is preferably used in this case as the transducer element.

An outer side 136 of the bottom wall 112 preferably extends perpendicularly to the main axis 118.

The transducer element is preferably connected, for example, adhesively bonded, to the receptacle 130. For this purpose, the inner side 120 preferably extends perpendicularly to the main axis 118 in the area of the receptacle 130. The receptacle 130 therefore has a thickness A.

In the plane of longitudinal section 126, the modulator area 132 is located between the receptacle 130 and the side wall 114. In the first embodiment, the modulator area 132 abuts the receptacle 130 by means of an inner transition 138. In addition, in the first embodiment the modulator area 132 abuts the side wall 114 by means of an outer transition 140.

The bottom wall 112 has the smallest thickness B at the outer transition 140. This radially outer smallest thickness B is less than the radially inner thickness A of the receptacle 130.

A thickness C at any arbitrary point of the modulator area 132 decreases gradually from the receptacle 130 to the transition 140. More precisely, in the first embodiment the thickness C of the bottom wall 112 decreases gradually from the inner transition 138 to the outer transition 140. In other words: each thickness C of a point on the inside in the modulator area 132 is less than the thickness A and greater than the thickness B.

Because the transitions 138, 140 are formed continuously in the first embodiment, the thickness C of the modulator area 132 at the inner edge of the modulator area 132 is equal to the thickness A and at the outer edge is equal to the thickness B.

In the first embodiment, the modulator area 132 has two truncated cone sections 150 and 152. A truncated cone section 150 arranged on the radial inside in the modulator area 132 has a proportionally large angle of inclination D. A truncated cone section 152 arranged on the radial outside in the modulator area 132 has a proportionally small angle of inclination E.

An advantageous compromise between directional characteristic and electroacoustic efficiency is achieved by the different angles of inclination D and E by means of the modulator area 132.

The angles of inclination D, E of a truncated cone 150, 152 or cone is in this case the conical angle between a base and a flank of the cone or truncated cone.

The inner side 120 has a planar section 134 in the area of each of the truncated cone sections 150, 152.

The truncated cone sections 150 and 152 merge into one another by means of a radially middle transition 154 in the first embodiment.

The inner transition 138 from the receptacle 130 into the inner truncated cone section 150 is a concave transition 156, thus a transition curved inward viewed from the interior 124.

The middle transition 154 from the inner truncated cone section 150 into the outer truncated cone section 152 and the outer transition 140 from the outer truncated cone section 152 into the side wall 114 are each a convex transition 158, thus a transition curved outward viewed from the interior 124.

Although FIG. 3 only shows half of the sectional surface of the plane of longitudinal section 126 with the bottom wall 112, FIG. 2 illustrates that there are two modulator areas 132 in the plane of longitudinal section 126, which are arranged symmetrically with respect to the main axis 118.

The side wall 114 has in the present case a section designed as a collar 160, which is arranged by way of example at an end of the side wall 114 remote from the bottom wall 112. The collar 160 protrudes radially outward, but has different widths viewed in the circumferential direction. FIG. 2 thus shows a narrow collar section 162 and a wide collar section 164. Due to the alternation of narrow and wide collar sections 162, 164, after the housing 110 is inserted into a recess formed diametrically opposite, for example, in a bumper of the vehicle 100, a twist lock is achieved. An orientation of the directional characteristic of the ultrasonic transducer 104 in the vehicle 100 can therefore be supervised and set.

Design advantages of the first embodiment will be discussed hereinafter. It is self-evident that these preferred dimensions and ratios are also each advantageous individually.

A distance from the main axis 118 to the transition 138 is designated as a radius F in FIG. 3. A distance from the main axis 118 to the inner side 122 of the side wall 114 is designated as a radius G or as a distance G. A difference between the thicknesses A and B is designated as a depth H. The depth H is a depth of a recess formed by the modulator area 132 in relation to the receptacle 130, cf. FIG. 2. Finally, an outer radius of the side wall 114 is designated by J.

A ratio of the radius G to the radius J influences the directional characteristic to a significant extent. The thinnest possible side wall 114 is thus pursued in the plane of longitudinal section 126. Advantageous ratios G/J are in the range greater than 0.9, preferably greater than 0.92.

For example, the radius F of the receptacle can be 4.1 mm, the distance G can be 7.1 mm, and/or the side wall 114 can be 0.6 mm thick in the plane of longitudinal section 126.

The directional characteristic is also influenced to a significant extent by the outer radius F of the receptacle 130. FIG. 2 shows by way of example that the side wall 114 has a thickening 170 in an area adjoining the bottom wall. The thickening 170 is designed such that it is spaced apart from the plane of longitudinal section 126 by approximately the radius F of the receptacle 130 and extends essentially parallel. “Approximately” in this specific context in particular means a range of +30% to −30% and preferably a range of +5% to −15%. The outer radius F of the receptacle 130 is primarily influenced by the transducer element to be installed. For example, a transducer element having a radius of 4 mm and an outer radius F of 4.1 mm matching thereto is proposed.

The directional characteristic is additionally decisively influenced by a ratio of the depth H to the outer thickness B. This also applies for the electroacoustic efficiency. Preferably, the depth H is greater in absolute value than the outer thickness B. According to experiments, a range of the ratio H/B of 1 to 2 and in particular of 1.2 to 1.5 is preferred.

Experiments have shown that the smallest angle of inclination E is to be at least 2° in order to display behavior which is robust with respect to manufacturing variations. Preferably, the smallest angle of inclination E is at least 2.5° and particularly preferably at least 3°. The angle of inclination is preferably measured or compared in relation to a perpendicular to the main axis 118.

Experiments have also shown that the steepest angle of inclination D is to be at least 25° and preferably at least 30°. In preferred variants having two truncated cone sections, the steeper angle of inclination D is 40° one time and 30° another time.

A radial extension of the modulator area 132 is the difference G-F. A preferred ratio of the depth H to a radial extension of the modulator area 132, thus a ratio H/(G-F), is in the range of 0.1 to 0.4, and preferably in the range of 0.15 to 0.25. In other words, the radially wider the modulator area 132 is, the more advantageous is a transmission behavior of the housing 110.

For a high electroacoustic efficiency, on the one hand, the above-described ratio H/B is important. On the other hand, the smoothest possible transition from the thickness A of the receptacle 130 to the thickness B of the bottom wall 112 in the area of the transition 140 into the side wall is to be pursued. The ratio of the angles of inclination D, E and the largest possible radius of the convex middle transition 154, 158 are advantageous for this purpose. In the present case, the middle transition 154 is embodied having an exemplary radius of 0.75 mm at a thickness B of 0.4 mm or a thickness A of 0.94 mm. By means of these measures, a radial mode or radial oscillation form of the preferred transducer element on a piezoelectric basis can advantageously be converted efficiently into a bending mode or bending oscillation mode of the ultrasonic transducer 106. The smooth form of the modulator section 132 ensures an equalization to the impedance of the transducer element here.

To shorten a reverberation after the emission of an ultrasonic pulse, two measures are proposed. First, the interior 124 can be potted or filled with a damping material after an installation of the transducer element. Silicone is preferred for this purpose. Second, linear surfaces between the transducer element or the receptacle 130 and the side wall 114 are to be avoided. In that the most curved possible surfaces are used, an introduction of energy into the damping material can be improved and can be distributed more uniformly than previously.

Finally, it is to be noted that the smoothest possible course of the modulator area 132 prevents burrs, imprints, and/or marks from arising on the outer side 136 of the bottom wall 112 during manufacturing, so that customer acceptance is improved.

A housing 200 according to a second embodiment of the invention is proposed hereinafter. Primarily, differences from the first embodiment are discussed here.

The second embodiment so to speak shows an ideal form of the invention. The housing 200 of the second embodiment has a modulator area 132, which has a continuous curvature 202 on the inner side 120 between the receptacle 130 and the side wall 114. A side wall-side angle of inclination or outer angle of inclination E is at least 2°, preferably at least 2.5°, and in particular at least 3°. A receptacle-side or inner angle of inclination D is 60° by way of example in the present case.

The transition 138 is embodied as a sharp edge 204. The transition 140 is embodied as a sharp edge 206.

The continuous curvature 202 follows, for example, a parabola open toward the side wall 114, so that the thickness C of the modulator area decreases more strongly close to the receptacle 130 than close to the side wall 114. The design of the continuous curvature 202 based on a recumbent parabola insofar corresponds to the proposal that of two truncated cone sections, the flatter one is preferably to be arranged on the radial outside. Instead of the parabolic shape, a course according to an exponential function is also preferred. Worded more generally: Experiments have shown that a continuously differentiable course of the inner side 120 of the bottom wall 114 has the smoothest course and therefore the highest electroacoustic efficiency. The continuously differentiable course can also be interpreted as the extreme shape of “at least two different angles of inclination”.

Moreover, reference is made to the description of the first embodiment, in particular to the description of preferred dimensions and ratios.

A housing 210 according to a third embodiment, shown in FIG. 5, differs from the housing 200 according to the second embodiment in the transition 138. Instead of the sharp edge 204, the concave rounding 156 is provided. Moreover, reference is made to the preceding description, in particular the second embodiment.

A housing 220 according to a fourth embodiment, shown in FIG. 6, differs from the housing 210 according to the third embodiment in the transition 140. Instead of the sharp edge 206, the convex rounding 158 is provided. Moreover, reference is made to the preceding description, in particular the second and third embodiments.

Finally, FIG. 7 shows a housing 230 according to a fifth embodiment. This differs from the first embodiment primarily in that instead of the middle transition 154 between the truncated cone sections 150 and 152, a sharp edge 232 is provided.

As a precaution it is to be noted with respect to the appended figures that the flattest angle of inclination in each of the figures is at least 2°, even if this fineness is difficult to illustrate in the figures.

The dimensions indicated each describe a preferred embodiment. They can assume other values individually or as a whole.

Although the present invention has been described on the basis of exemplary embodiments, it may be modified in diverse ways.

### LIST OF REFERENCE SIGNS

100 vehicle
102 surroundings
104 control unit
106 ultrasonic transducer
110 housing
112 bottom wall
114 side wall
118 main axis
120 inner side of the bottom wall
122 inner side of the side wall
124 interior
126 plane of longitudinal section
130 receptacle
132 modulator area
134 planar section
136 outer side
138 inner transition
140 outer transition
150 truncated cone section
152 truncated cone section
154 middle transition
156 concave transition
158 convex transition
160 collar
162 collar section
164 collar section
170 thickening
200 housing
202 continuous curvature
204 sharp edge
206 sharp edge
210 housing
220 housing
230 housing
232 sharp edge
A inner thickness
B outer thickness
C thickness of the modulator area
D inner angle of inclination
E outer angle of inclination
F radius
G radius
H depth
J radius

1. A housing for an ultrasonic transducer for detecting an object in a surroundings of a vehicle, the housing comprising:
a circumferential side wall, which defines a main axis of the housing; and
a bottom wall, which has a central receptacle for supporting a transducer element and at least one modulator area,
wherein the modulator area extends in a plane of longitudinal section, which contains the main axis, radially from the receptacle to a transition of the bottom wall into the side wall,
wherein a thickness of the bottom wall decreases radially outward over the entire modulator area, and
wherein an inner side of the bottom wall in the modulator area has at least two different angles of inclination.

2. The housing as claimed in claim 1, wherein the inner side of the modulator area extends in a convex rounding in the plane of longitudinal section.

3. The housing as claimed in claim 1, wherein the inner side extends continuously differentiably at least once in the plane of longitudinal section.

4. The housing as claimed in claim 1, wherein the modulator area contains multiple truncated cone sections having different angles of inclination.

5. The housing as claimed in claim 4, wherein at least two radially adjacent truncated cone sections merge into one another through a convex rounding.

6. The housing as claimed in claim 1, wherein a planar section of the modulator area is arranged further radially outward the flatter the respective planar section is.

7. The housing as claimed in claim 1, wherein the modulator area or in each case a modulator area extends symmetrically to the main axis in the plane of longitudinal section.

8. The housing as claimed in claim 1, wherein the side wall has a thickening parallel to the plane of longitudinal section,

9. The housing as claimed in claim 1, wherein an angle of inclination on the inside in the modulator area is at least 2°.

10. The housing as claimed in claim 1, wherein the side wall is interrupted at least in some sections in a circumferential direction and/or protrudes by different distances from the main axis viewed along the circumferential direction.

11. The housing as claimed in claim 1, wherein the inner side of the bottom wall merges by means of a concave rounding from the modulator area into the receptacle.

12. The housing as claimed in claim 1, wherein the inner side of the bottom wall merges by means of a convex rounding from the modulator area into an inner side of the side wall.

13. The housing as claimed in claim 1, wherein the receptacle has a constant thickness.

14. An ultrasonic transducer for detecting an object in the surroundings of a vehicle, comprising a housing as claimed in claim 1 and a transducer element supported on and/or in the receptacle.

15. A vehicle having an ultrasonic transducer as claimed in claim 14.
